(19) United States
(12) Patent Application Publication
(10) Pub. No.: US 2022/0341220 A1
(43) Pub. Date: Oct. 27, 2022

(54) ARTICLE MANAGEMENT APPARATUS, ARTICLE MANAGEMENT SYSTEM, ARTICLE MANAGEMENT METHOD AND RECORDING MEDIUM

(71) Applicant: NEC Corporation, Minato-ku, Tokyo (JP)

(72) Inventors: Yasuji SAITO, Tokyo (JP); Hajime SUZUKI, Tokyo (JP)

(73) Assignee: NEC Corporation, Minato-ku, Tokyo (JP)

(21) Appl. No.: 17/642,389

(22) PCT Filed: Aug. 6, 2020
(86) PCT No.: PCT/JP2020/030170

§ 371 Date: Mar. 11, 2022

(30) Foreign Application Priority Data
Sep. 25, 2019 (JP) 2019-174145

(51) Int. Cl. E05B 49/00; G06Q 50/10; G07C 9/00

(52) U.S. Cl. CPC E05B 49/00; G06Q 50/10; G07C 9/00

(57) ABSTRACT

An article management apparatus includes: an identifying unit that performs an identification process for identifying a user that enters a facility in which a storage for an article is placed; a storing unit that stores usage condition data that defines a condition for the user that is identified by the identifying unit to use the storage; and a changing unit that performs a change process for changing the usage condition data stored in the storing unit on the basis of a predetermined change information that is usable for changing the usage condition data.

### TECHNICAL FIELD

The present invention relates to a technical field of an article management apparatus, an article management system, an article management method and a recording medium for managing a usage of a storage of an article.

### BACKGROUND ART

A Patent Literature 1 discloses, as one example of an article management system, an article management system that permits a user to use a key stored in a key storage box by unlocking a lock of the locked key storage box for storing the key of a client. Specifically, the article management system disclosed in the Patent Literature 1 authenticates the user by a biometric authentication, notifies a terminal of the client that the user is trying to use the key in the key storage box when the authentication succeeds, and unlocks the lock of the key storage box when receiving from the terminal of the client a notification that permits the usage of the key in the key storage box.

In addition, there are a Patent Literature 1 to a Patent Literature 6 as a background art document relating to the present invention.

### CITATION LIST

### Patent Literature

Patent Literature 1: JP2007-332650A
Patent Literature 2: WO2011/033756A1
Patent Literature 3: JP2017-521780A
Patent Literature 4: JP2014-197328A
Patent Literature 5: JP2010-006388A
Patent Literature 6: JP2005-301331A

### SUMMARY

### Technical Problem

The article management system disclosed in the Patent Literature 1 has a technical problem that there is a room for an improvement in that the usage of the key storage box by the user is properly managed. Moreover, not only the article management system that manages the usage of the key storage box for storing the key but also an article management system that manages an usage of any storage for storing any article also has a technical problem that there is a room for an improvement in that the usage of the storage by the user is properly managed.

It is therefore an example object of the present invention to provide an article management apparatus, an article management system, an article management method and a recording medium that can solve the technical problems described above. As one example, the example object of the present invention is to provide an article management apparatus, an article management system, an article management method and a that are configured to properly manage an usage of a storage of an article.

### Solution to Problem

A first article management apparatus includes: an identifying unit that performs an identification process for identifying a user that enters a facility in which a storage for an article is placed; a storing unit that stores usage condition data that defines a condition for the user that is identified by the identifying unit to use the storage; and a changing unit that performs a change process for changing the usage condition data stored in the storing unit on the basis of a predetermined change information that is usable for changing the usage condition data.

A second article management apparatus includes: an identifying unit that performs an identification process for identifying a user that enters a facility in which a storage for an article is placed; a storing unit that stores usage condition data that defines a condition of the storage that is usable by the user; and a managing unit that determines on the basis of the usage condition information whether or not the usage of the storage by the user is permitted when it receives a request information relating to a request from the user that wants to use the storage, and performs a predetermined management process that should be performed when the usage of the storage is permitted when it is determined that the usage of the storage by the user is permitted, the management unit performing the management process on the condition that a predetermined additional condition is satisfied even when it is determined that the usage of the storage by the user is not permitted.

A first article management system includes: an article management apparatus that manages an usage for an article; and an information terminal that is usable by a user that enters a facility in which the storage is placed, the information terminal includes a transmitting unit that transmits, to the article management apparatus, a request information relating to a request from the user that wants to use the storage, the article management apparatus includes: an identifying unit that performs an identification process for identifying the user; a storing unit that stores usage condition data that defines a condition for the user that is identified by the identifying unit to use the storage; a managing unit that manages the usage of the storage by the user on the basis of the request information and the usage condition data; and a changing unit that performs a change process for changing the usage condition data stored in the storing unit on the basis of a predetermined change information that is usable for changing the usage condition data.

A second article management system includes: an article management apparatus that manages an usage for an article; and an information terminal that is usable by a user that enters a facility in which the storage is placed, the information terminal includes a transmitting unit that transmits, to the article management apparatus, a request information relating to a request from the user that wants to use the storage, the article management apparatus includes: an identifying unit that performs an identification process for identifying the user; a storing unit that stores usage condition data that defines a condition for the user that is identified by the identifying unit to use the storage; a managing unit that (i) determines on the basis of the usage condition information whether or not the usage of the storage by the user is permitted when it receives the request information, and (ii) performs a predetermined management process that should be performed when the usage of the storage is permitted when it is determined that the usage of the storage by the user is permitted, the management unit performing the management process on the condition that a predetermined additional condition is satisfied even when it is determined that the usage of the storage by the user is not permitted.

A first article management method includes: performing an identification process for identifying a user that enters a facility in which a storage for an article is placed; and performing a change process for changing usage condition data that defines a condition for the identified user to use the storage on the basis of a predetermined change information that is usable for changing the usage condition data.

A second article management method includes: performing an identification process for identifying a user that enters a facility in which a storage for an article is placed; determining, on the basis of usage condition information that defines a condition of the storage that is usable by the user, whether or not the usage of the storage by the user is permitted when a request information relating to a request from the user that wants to use the storage is received; performing a predetermined management process that should be performed when the usage of the storage is permitted when it is determined that the usage of the storage by the user is permitted; and performing the management process on the condition that a predetermined additional condition is satisfied even when it is determined that the usage of the storage by the user is not permitted.

A first recording medium is a recording medium on which a computer program allowing a computer to execute an article management method is recorded, the article management method includes: performing an identification process for identifying a user that enters a facility in which a storage for an article is placed; and performing a change process for changing usage condition data that defines a condition for the identified user to use the storage on the basis of a predetermined change information that is usable for changing the usage condition data.

A second recording medium is a recording medium on which a computer program allowing a computer to execute an article management method is recorded, the article management method includes: performing an identification process for identifying a user that enters a facility in which a storage for an article is placed; determining, on the basis of usage condition information that defines a condition of the storage that is usable by the user, whether or not the usage of the storage by the user is permitted when a request information relating to a request from the user that wants to use the storage is received; performing a predetermined management process that should be performed when the usage of the storage is permitted when it is determined that the usage of the storage by the user is permitted; and performing the management process on the condition that a predetermined additional condition is satisfied even when it is determined that the usage of the storage by the user is not permitted.

### Advantageous Effects of Invention

Each of the first and second article management apparatuses, the first and second article management systems, the first and second article management methods and the first and second recording media is capable of properly managing an usage of the storage of the article.

### BRIEF DESCRIPTION OF DRAWINGS

FIG. 1 is a block diagram that illustrates an entire configuration of a store management system in a present example embodiment.

FIG. 2 is a floor view that illustrates one example a store that adopts the store management system in the present example embodiment.

FIG. 3 a side view that conceptually illustrates an entrance of the store.

FIG. 4 Each of FIG. 4A to FIG. 4D is a side view that conceptually illustrates a goods shelf a security level of which is set to be a predetermined level.

FIG. 5 is a block diagram that illustrates a configuration of a store management server in the present example embodiment.

FIG. 6 Each of FIG. 6A and FIG. 6B is a data structure diagram that illustrates usage condition data.

FIG. 7 is a block diagram that illustrates a configuration of a user terminal in the present example embodiment.

FIG. 8 is a flow chart that illustrates a flow of an operation performed by the store management server when the user enters a shopping space.

FIG. 9 is a flow chart that illustrates a flow of an operation performed by the store management server when the user purchases a goods in the shopping space.

FIG. 10 is a flow chart that illustrates a flow of an operation for changing the usage condition data.

FIG. 11 is a table that illustrates an aspect of changing the usage condition data (especially, user condition data).

### DESCRIPTION OF EXAMPLE EMBODIMENTS

Next, with reference to the drawings, an example embodiment of an article management apparatus, an article management system, an article management method and a recording medium will be described. In the below described description, the example embodiment of the article management apparatus, the article management system, the article management method and the recording medium will be described by using a store management system SYS for managing a usage of a goods shelf SH by a user who visits a store ST in which the goods shelf SH on which a goods are displayed is placed.

(1) Configuration of Store Management System SYS

(1-1) Entire Configuration of Store Management System SYS

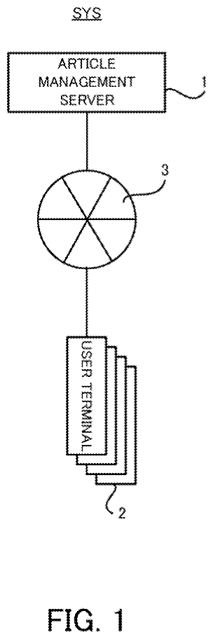

Firstly, with reference to FIG. 1, an entire configuration of the store management system SYS in the present example embodiment will be described. FIG. 1 is a block diagram that illustrates an entire configuration of the store management system SYS in the present example embodiment.

As illustrated in FIG. 1, the store management system SYS includes a store management server 1 and a plurality of user terminals 2. The store management system SYS may include the user terminals 2 the number of which is equal to the number of the users that uses the store ST, because the user terminal 2 is an information terminal that the user uses (in other words, has). The store management server 1 is configured to communicate with the plurality of user terminals 2 through a network 3. The network 3 may include a wired network and may include a wireless network.

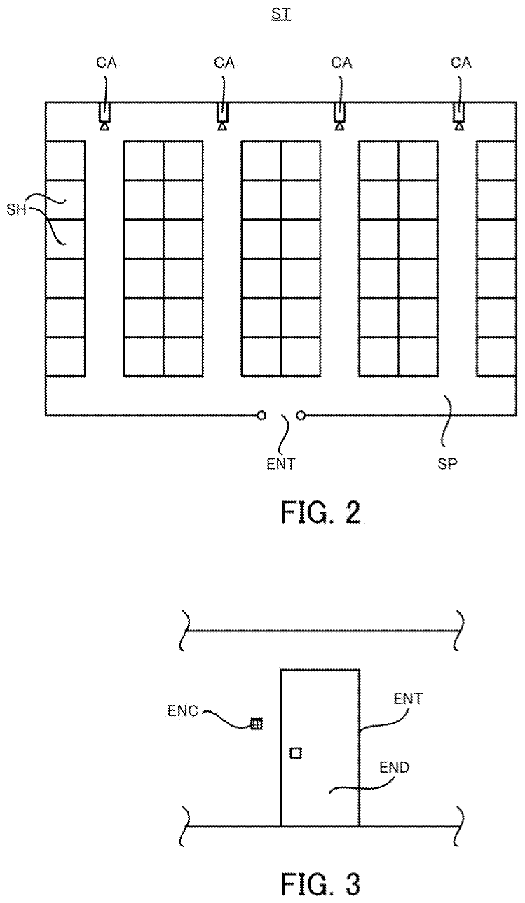

FIG. 2 illustrates, as a floor view of the store ST, one example of the store ST that adopts the store management system SYS. For example, as illustrated in FIG. 2, the store ST includes a shopping space SP. The user is allowed to enter the shopping space SP from an outside of the store ST (alternatively, an outside of the shopping space SP) through an entrance ENT of the store ST. An entrance door END is placed at the entrance ENT as illustrated in FIG. 3 that is a side view conceptually illustrating the entrance ENT. Furthermore, a QR code (a Registered Trademark) ENC is placed near the entrance ENT at the outside of the shopping space SP. The user reads the QR code ENC by using the user terminal 2 in order to enter the shopping space SP. A read result of the QR code ENC is transmitted from the user terminal 2 to the store management server 1 through the network 3. The store management server 1 performs an identification process for identifying the user that is about to enter the store ST on the basis of the read result of the QR code ENC. After the identification process is completed, the store management server 1 transmits an unlocking command for unlocking the entrance door END to the entrance door END (alternatively, a control apparatus that controls an opening and an closing of the entrance door END). As a result, the entrance door END is unlocked and the user can enter the shopping space SP.

A plurality of goods shelves SH are placed in the shopping space SP. A goods that is sold in the store ST is displayed (namely, stored) on each goods shelf SH. A unique security level is set for each goods shelf SH. Namely, the security level of each goods shelf SH is set to be one level of a plurality of levels. The user is authorized to pick up the goods displayed on the goods shelf SH the security level of which is set to be one that is usable by the user (specifically, that permits the user to use). On the other hand, the user is not authorized to pick up the goods displayed on the goods shelf SH the security level of which is set to be one that is not usable by the user.

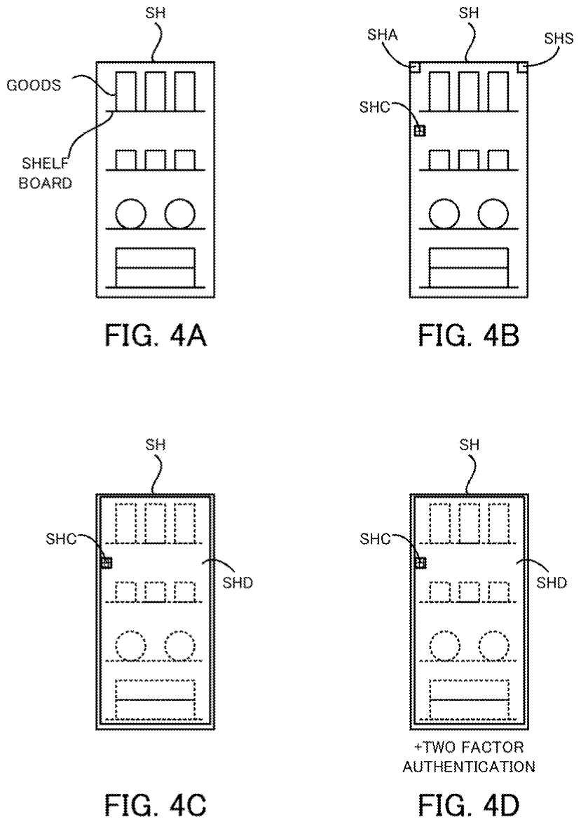

The present example embodiment describes an example in which the security level of each goods shelf SH is set to be one of a level 1 to a level 4. Next, the with reference to FIG. 4A to FIG. 4D, the security level that is set for each goods shelf SH will be described.

FIG. 4A is a side view that conceptually illustrates the goods shelf SH the security level of which is set to be the level 1 (hereinafter, it is referred to as a “goods shelf SH (level 1)”). As illustrated in FIG. 4A, the goods shelf SH (level 1) does not include a door that separates an inside and an outside of the goods shelf SH. Thus, the user can freely pick up the goods displayed on the goods shelf SH (level 1). Namely, the level 1 is a security level in which the door that separates the inside and the outside of the goods shelf SH is not necessarily placed and the user can freely pick up the displayed goods.

FIG. 4B is a side view that conceptually illustrates the goods shelf SH the security level of which is set to be the level 2 (hereinafter, it is referred to as a “goods shelf SH (level 2)”). As illustrated in FIG. 4B, the goods shelf SH (level 2) does not include the door that separates the inside and the outside of the goods shelf SH. However, a QR code SHC is placed in the goods shelf SH (level 2). The user reads the QR code SHC by using the user terminal 2 in order to pick up the goods displayed on the goods shelf SH (level 2). A read result of the QR code SHC is transmitted from the user terminal 2 to the store management server 1 through the network 3. The store management server 1 manages an usage history of the goods shelf SH (level 2) on the basis of the read result of the QR code SHC. Namely, the store management server 1 manages an information relating to the user that uses the goods shelf SH (level 2) (namely, the user that picks up the goods displayed on the goods shelf SH (level 2)). However, the goods shelf SH (level 2) does not include the door. Thus, the user that does not read the QR code SHC can pick up the goods displayed on the goods shelf SH (level 2), as with the user that reads the QR code SHC. Thus, in order to make the user that does not read the QR code SHC read the QR code SHC, a sensor SHS and an alert apparatus SHA are placed in the goods shelf SH (level 2). The sensor SHS detects whether or not the user picks up the goods displayed on the goods shelf SH. A detected result by the sensor SHS is transmitted to the store management server 1. The store management server 1 outputs an alert by using the alert apparatus SHA when the sensor SHS outputs the detected result indicating that the user picks up the goods displayed on the goods shelf SH even though the read result of the QR code SHC is not transmitted. On the other hand, the store management server 1 may not output the alert by using the alert apparatus SHA when the sensor SHS outputs the detected result indicating that the user picks up the goods displayed on the goods shelf SH in a situation where the read result of the QR code SHC is not transmitted. Furthermore, the store management server 1 outputs the alert by using the alert apparatus SHA when the user that transmits the read result of the QR code SHC is an user that is not permitted to use the goods shelf SH (level 2). On the other hand, the store management server 1 may not output the alert by using the alert apparatus SHA when the user that transmits the read result of the QR code SHC is an user that is permitted to use the goods shelf SH (level 2). The output of the alert may include at least one of an output of an alert sound and an output of an alert screen. The alert may include at least one of an alert that informs the user to refrain from using the goods shelf SH (level 2) and an alert that prompts the user to read the QR code SHC. As described above, the level 2 is a security level that is more stringent than the level 1.

FIG. 4C is a side view that conceptually illustrates the goods shelf SH the security level of which is set to be the level 3 (hereinafter, it is referred to as a “goods shelf SH (level 3)”). As illustrated in FIG. 4C, the goods shelf SH (level 3) includes a door SHD that separates the inside and the outside of the goods shelf SH. An unlocking of the door SHD is controllable by the store management sever 1. The QR code SHC is further placed in the goods shelf SH (level 3). The user reads the QR code SHC by using the user terminal 2 in order to pick up the goods displayed on the goods shelf SH (level 3). The read result of the QR code SHC is transmitted from the user terminal 2 to the store management server 1 through the network 3. The store management server 1 manages an usage history of the goods shelf SH (level 3) on the basis of the read result of the QR code SHC. Furthermore, the store management server 1 transmits an unlocking command for unlocking the door SHD to the door SHD (alternatively, a control apparatus that controls an opening and an closing of the door SHD) when the user that transmits the read result of the QR code SHC is an user that is permitted to use the goods shelf SH (level 3). As a result, the door SHD is unlocked and the user can pick up the goods displayed on the goods shelf SH (level 3). On the other hand, the store management server 1 does not transmit the unlocking command for unlocking the door SHD to the door SHD (alternatively, the control apparatus that controls the opening and the closing of the door SHD) when the user that transmits the read result of the QR code SHC is an user that is not permitted to use the goods shelf SH (level 3). As a result, the door SHD is not unlocked and the user cannot pick up the goods displayed on the goods shelf SH (level 3). As described above, the level 3 is a security level that is more stringent than the level 1 and the level 2. Note that at least one of the sensor SHS and the alert apparatus SHA may be placed in the goods shelf SH (level 3), as with the goods shelf SH (level 2).

FIG. 4D is a side view that conceptually illustrates the goods shelf SH the security level of which is set to be the level 4 (hereinafter, it is referred to as a “goods shelf SH (level 4)”). As illustrated in FIG. 4D, the goods shelf SH (level 4) includes the door SHD, as with the goods shelf SH (level 3). Furthermore, the QR code SHC is placed in the goods shelf SH (level 4), as with the goods shelf SH (level 3). The user reads the QR code SHC by using the user terminal 2 in order to pick up the goods displayed on the goods shelf SH (level 4). The read result of the QR code SHC is transmitted from the user terminal 2 to the store management server 1 through the network 3. The store management server 1 manages an usage history of the goods shelf SH (level 4) on the basis of the read result of the QR code SHC. Furthermore, the store management server 1 requests a two factor authentication from the user that transmits the read result of the QR code SHC. For example, the store management server 1 may transmit a security code for the two factor authentication to an e-mail address and so on of the user that transmits the read result of the QR code SHC and request the user to input the security code by using the user terminal 2. The store management server 1 transmits the unlocking command for unlocking the door SHD to the door SHD (alternatively, the control apparatus that controls the opening and the closing of the door SHD) when the user that transmits the read result of the QR code SHC is an user that is permitted to use the goods shelf SH (level 4) and the two part authentication is successfully completed. As a result, the door SHD is unlocked and the user can pick up the goods displayed on the goods shelf SH (level 4). On the other hand, the store management server 1 does not transmit the unlocking command for unlocking the door SHD to the door SHD (alternatively, the control apparatus that controls the opening and the closing of the door SHD) when the user that transmits the read result of the QR code SHC is an user that is not permitted to use the goods shelf SH (level 4). Furthermore, the store management server 1 does not transmit the unlocking command for unlocking the door SHD to the door SHD (alternatively, the control apparatus that controls the opening and the closing of the door SHD) when the two part authentication is not successfully completed. As a result, the door SHD is not unlocked and the user cannot pick up the goods displayed on the goods shelf SH (level 4). As described above, the level 3 is a security level that is more stringent than the level 1 to the level 3. Note that at least one of the sensor SHS and the alert apparatus SHA may be placed in the goods shelf SH (level 4), as with the goods shelf SH (level 2).

The security level may be set on the basis of a characteristic of the goods displayed on the goods shelf SH. For example, the security level that is set for the goods shelf SH on which the goods that requires a relatively strict management is displayed may be set to be a level that is more stringent than the security level that is set for the goods shelf SH on which the goods that does not require the relatively strict management (namely, a loose management is sufficient) is displayed. For example, the security level that is set for the goods shelf SH on which the relatively expensive goods is displayed may be set to be a level that is more stringent than the security level that is set for the goods shelf SH on which the relatively cheap goods is displayed.

At least one a security camera CA may be further placed in the shopping space SP. The security camera CA may be placed to capture an image of at least one goods shelf SH. The security camera CA may be placed to capture an image of the user that is located near at least one goods shelf SH. However, the security camera CA may not be placed in the shopping space SP.

The user that has picked up the goods from the goods shelf SH pay for the goods by using a not-illustrated payment terminal (for example, a POS (Point of Sale System) terminal such as a self-service checkout machine). The user that has paid for the goods can leave the shopping space SP to the outside of the shopping space SP through the entrance ENT. Note that the store management sever 1 may perform an identification process for identifying the user that is about to leave the store ST in order to manage the user that stays in the store ST when the user leaves the store. For example, the user may read a QR code that is placed near the entrance ENT in the shopping space SP by using the user terminal 2 in order to leave the shopping space SP. The store management sever 1 may perform the identification process for identifying the user that is about to leave the store ST on the basis of a read result of the QR code. After the identification process is completed, the store management server 1 may transmit the unlocking command for unlocking the entrance door END to the entrance door END (alternatively, the control apparatus that controls the opening and the closing of the entrance door END). As a result, the entrance door END is unlocked and the user can leave the shopping space SP.

(1-2) Configuration of Store Management Server 1

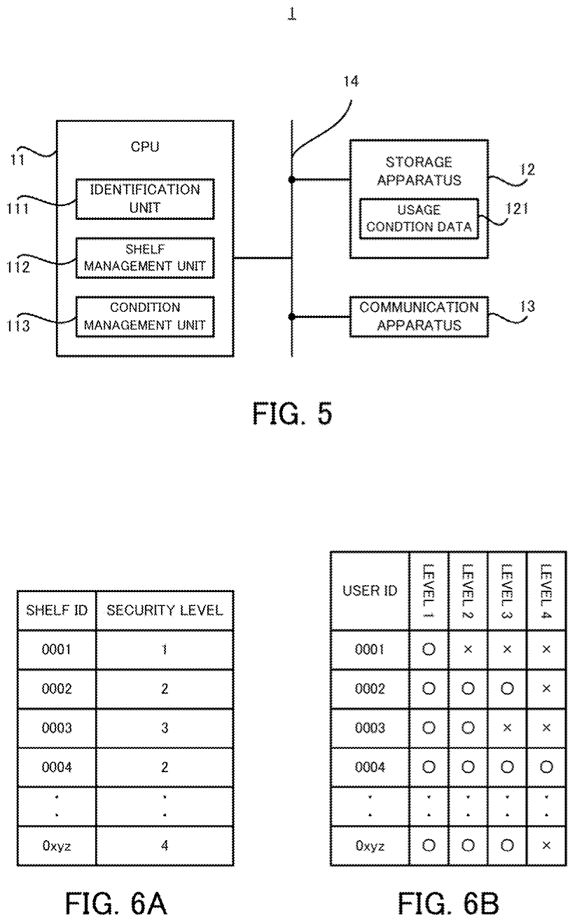

Next, with reference to FIG. 5, a configuration of the store management sever 1 in the present example embodiment will be described. FIG. 5 is a block diagram that illustrates the configuration of the store management sever 1 in the present example embodiment.

As illustrated in FIG. 5, the store management server 1 includes a CPU (Central Processing Unit) 11, a storage apparatus 12 and a communication apparatus 13. The CPU 11, the storage apparatus 12 and the communication apparatus 13 are interconnected through a data bus 14.

The CPU 11 reads a computer program. For example, the CPU 11 may read a computer program stored in the storage apparatus 12. For example, the CPU 11 may read a computer program stored in a computer-readable recording medium, by using a not-illustrated recording medium reading apparatus. The CPU 11 may obtain (namely, download or read) a computer program from a not-illustrated apparatus placed outside the store management server 1 through the communication apparatus 13. The CPU 11 executes the read computer program. As a result, a logical functional block for performing an operation that should be performed by the store management server 1 is implemented in the CPU 11. Namely, the CPU 11 is configured to serve as a controller for implementing the logical block for performing the operation that should be performed by the store management server 1.

One example of the logical functional block that is implemented in the CPU 11 for performing the operation that should be performed by the store management server 1 is illustrated in FIG. 5. As illustrated in FIG. 5, an identification unit 111, a shelf management unit 112 and a condition management unit 113 are implemented in the CPU 11. Note that an operation of each of the identification unit 111, the shelf management unit 112 and the condition management unit 113 will be described later in detail with reference to FIG. 8 to FIG. 10 and so on, however, an overview thereof will be described briefly here. The identification unit 111 performs the identification process for identifying the user that is about to enter the store ST. The identification unit 111 may perform the identification process for identifying the user that is about to leave the store ST. The shelf management unit 112 manages the usage of the goods shelf SH by the user. Specifically, the shelf management unit 112 determines whether or not the user is permitted to use the goods shelf SH on the basis of usage condition data that defines a condition for the user to use the goods shelf SH, and performs a necessary process (for example, at least one of a process for controlling the alert apparatus SHA and a process for controlling the unlocking of the door SHD described above) on the basis of a determined result. Furthermore, the shelf management unit 112 may manage the usage history of the goods shelf SH (level 2). The condition management unit 113 manages the usage condition data that defines the condition for the user to use the goods shelf SH. Especially, the condition management unit 113 changes (in other words, updates) the usage condition data if needed.

The usage condition data may include shelf condition data that indicates the security level set for the goods shelf SH for each goods shelf SH as illustrated in FIG. 6A. The shelf condition data includes a plurality of records in each of which a shelf ID for identifying the goods shelf SH and the security level set for the goods shelf SH are associated, for example. In an example illustrated in FIG. 6A, the shelf condition data indicates that the security level of the goods shelf SH the shelf ID of which is 0001 is the level 1, the security level of the goods shelf SH the shelf ID of which is 0002 is the level 2, the security level of the goods shelf SH the shelf ID of which is 0003 is the level 3, the security level of the goods shelf SH the shelf ID of which is 0004 is the level 2, . . . , and the security level of the goods shelf SH the shelf ID of which is 0xyz is the level 4.

The usage condition data may include user condition data that indicates the security level that is usable by the user (namely, that is permitted to be used by the user) for each user as illustrated in FIG. 6B. The user condition data includes a plurality of records in each of which a user ID for identifying the user and the security level that is usable by the user are associated, for example. In an example illustrated in FIG. 6B, the user condition data indicates that (i) the user the user ID of which is 0001 is permitted to use the goods shelf SH the security level of which is set to be the level 1 and is not permitted to use the goods shelf SH the security level of which is set to be either one of the level 2 to the level 4, (ii) the user the user ID of which is 0002 is permitted to use the goods shelf SH the security level of which is set to be either one of the level 1 to the level 3 and is not permitted to use the goods shelf SH the security level of which is set to be the level 4, (iii) the user the user ID of which is 0003 is permitted to use the goods shelf SH the security level of which is set to be the level 1 or the level 2 and is not permitted to use the goods shelf SH the security level of which is set to be level 3 or the level 4, (iv) the user the user ID of which is 0004 is permitted to use the goods shelf SH the security level of which is set to be either one of the level 1 to the level 4, and (v) the user the user ID of which is 0xyz is permitted to use the goods shelf SH the security level of which is set to be either one of the level 1 to the level 3 and is not permitted to use the goods shelf SH the security level of which is set to be the level 4.

When the user is permitted to use the goods shelf SH that includes the door SHD described above, the door SHD is unlocked. Thus, it can be said that the usage condition data substantially includes unlocking condition data relating to an unlocking condition that indicates whether or not the unlocking of the door SHD is permitted to the user. This unlocking condition data corresponds to data that indicates whether or not the usage of the goods shelf SH the security level of which is set to be the level 3 or the level 4 is allowed for the user.

Again in FIG. 5, the storage apparatus 12 is configured to store a desired data. For example, the storage apparatus 12 may temporarily store the computer program that is executed by the CPU 11. The storage apparatus 2 may temporarily store a data that is temporarily used by the CPU 11 when the CPU 11 executes the computer program. The storage apparatus 12 may store a data that is stored for a long term by the store management server 1. The storage apparatus 12 may include at least one of a RAM (Random Access Memory), a ROM (Read Only Memory), a hard disk apparatus, a magneto-optical disc, a SSD (Solid State Drive) and a disk array apparatus. Note that the above described usage condition data may be stored in the storage apparatus 12.

The communication apparatus 13 is configured to communicate with the plurality of user terminals 2 through the network 3. Namely, the communication apparatus 13 is configured to transmit an information to the plurality of user terminals 2 through the network 3. The communication apparatus 13 is configured to receive an information from the plurality of user terminals 2 through the network 3.

(1-3) Configuration of User Terminal 2

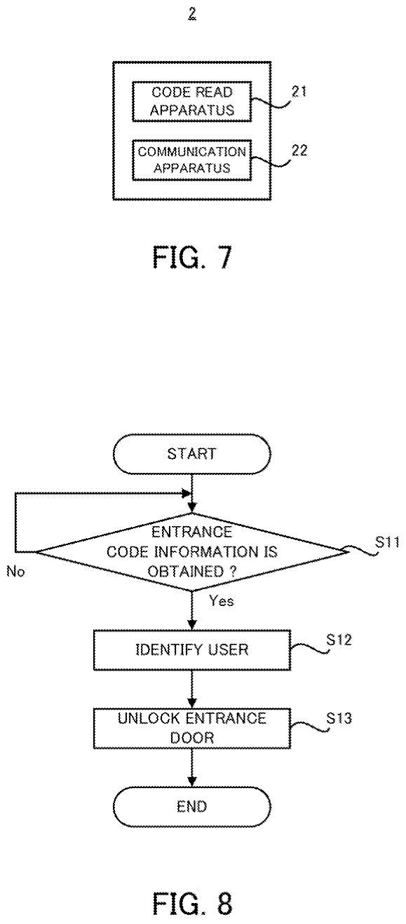

Next, with reference to FIG. 7, a configuration of the user terminal 2 in the present example embodiment will be described. FIG. 7 is a block diagram that illustrates the configuration of the user terminal 2 in the present example embodiment.

As illustrated in FIG. 7, the user terminal 2 includes a code read apparatus 21 and a communication apparatus 22.

The code read apparatus 21 is configured to read each of the QR code ENC that is placed near the entrance ENT of the store ST and the QR code SHC that is placed in the goods shelf SH. Namely, the code read apparatus 21 is configured to optically read each of the QR code ENC and the QR code SHC.

The communication apparatus 22 is configured to communicate with the store management sever 1 through the network 3. For example, the communication apparatus 22 may transmit an information relating to each of the QR code ENC and the QR code SHC that are read by the code read apparatus 21 through the network 3.

(2) Operation of Store Management System SYS

Next, an operation that is performed by the store management system SYS when the user shops in the store ST will be described. In the present example embodiment, the store management system SYS performs at least one of an operation that is performed when the user enters the shopping space SP (namely, when the user enters the store ST), an operation that is performed when the user purchases the goods in the shopping space SP and an operation for changing the usage condition data. Thus, in the below described description, these three operations will be described in sequence.

In the present example embodiment, the store management server 1 mainly performs each process described above by using the plurality of user terminals 2. Thus, in the below described description, the operation performed by the store management server 1 sill be described as the operation performed by the store management system SYS for convenience of description.

(2-1) Operation Performed when User Enters Shopping Space SP

Firstly, with reference to FIG. 8, the operation that is performed by the store management server 1 when the user enters the shopping space SP will be described. FIG. 8 is a flowchart that illustrates a flow of the operation that is performed by the store management server 1 when the user enters the shopping space SP. Note that the operation illustrated in FIG. 8 may be performed repeatedly by the store management server 1. Namely, when the operation illustrated in FIG. 8 ends, the store management server 1 may start the operation illustrated in FIG. 8 again after a predetermined time elapses.

When the user enters the shopping space SP, the user reads the QR code ENC that is placed near the entrance ENT by using the user terminal 2 as described above. The read result of the QR code ENC is transmitted from the user terminal 2 to the store management server 1 through the network 3. Thus, the identification unit 111 of the store management server 1 determines whether or not an entrance code information corresponding to the read result of the QR code ENC is obtained (namely, received) (a step S11).

As a result of the determination at the step S11, when it is determined that the entrance code information is not obtained (the step S11: No), the identification unit 111 continues to determine whether or not the entrance code information is obtained (the step S11). On the other hand, as a result of the determination at the step S11, when it is determined that the entrance code information is obtained (the step S11: Yes), the identification unit 111 identifies the user by performing the identification process of the user using the entrance code information (a step S12). Namely, the identification unit 111 determines which of the plurality of users registered in the store management server 1 is the user that transmits the entrance code information.

The entrance code information may include an information for identifying the user in order to identify the user. For example, the entrance code information may include an information for identifying the user terminal 2 that is used by the user as the information for identifying the user. The information for identifying the user terminal 2 is usable as the information for identifying the user that uses the user terminal 2, because the user terminals 2 and the users are associated one for one.

Then, the identification unit 111 transmits the unlocking command for unlocking the entrance door END to the entrance door END (alternatively, the control apparatus that controls the opening and the closing of the entrance door END) (a step S13). As a result, the entrance door END is unlocked and the user can enter the shopping space SP.

(2-2) Operation Performed when User Purchases Goods in Shopping Space SP

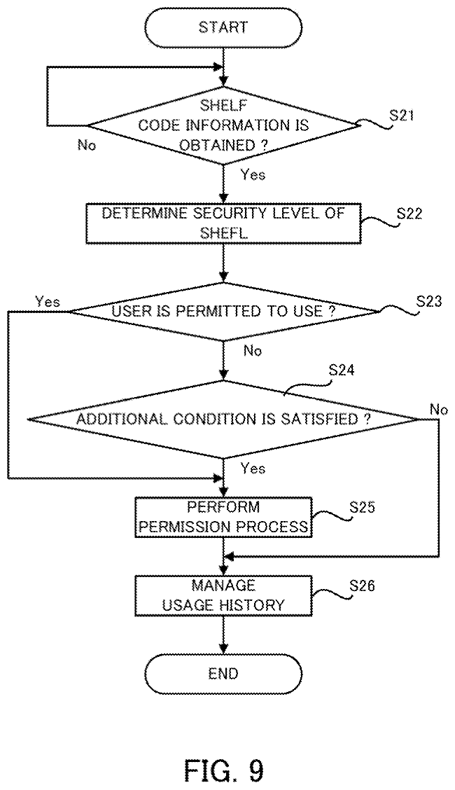

Next, with reference to FIG. 9, the operation that is performed by the store management server 1 when the user purchases the goods in the shopping space SP will be described. FIG. 9 is a flowchart that illustrates a flow of the operation that is performed by the store management server 1 when the user purchases the goods in the shopping space SP. Note that the operation illustrated in FIG. 9 may be performed repeatedly by the store management server 1. Namely, when the operation illustrated in FIG. 9 ends, the store management server 1 may start the operation illustrated in FIG. 9 again after a predetermined time elapses.

When the user shops in the shopping space SP, the user reads the QR code SHC that is placed in the goods shelf SH on which the goods, which the user wants to purchase, is displayed by using the user terminal 2. The read result of the QR code SHC is transmitted from the user terminal 2 to the store management server 1 through the network 3. Thus, the shelf management unit 112 of the store management server 1 determines whether or not a shelf code information corresponding to the read result of the QR code SHC is obtained (namely, received) (a step S21). The shelf code information typically includes an information for identifying the goods shelf SH in which the QR code SHC is placed and an information for identifying the user that reads the QR code SHC (for example, the information for identifying the user terminal 2 described above).

The read result of the QR code SHC is substantially equivalent to an information indicating that the user wants (namely, requests) to use the goods shelf SH (namely, pick up the goods displayed on the goods shelf SH). This is because the QR code SHC is read when the user wants to use the goods shelf SH. Thus, an operation for transmitting the shelf code information is substantially equivalent to an operation for transmitting an information regarding a request of the usage of the goods shelf SH by the user. An operation for determining whether or not the shelf code information is obtained is substantially equivalent to an operation for determining whether or not the information regarding a request of the usage of the goods shelf SH by the user is obtained. The operation for determining whether or not the shelf code information is obtained is substantially equivalent to an operation for determining whether or not the user wants (namely, requests) to use the goods shelf SH.

As a result of the determination at the step S21, when it is determined that the shelf code information is not obtained (the step S21: No), the shelf management unit 112 continues to determine whether or not the shelf code information is obtained (the step S21). On the other hand, as a result of the determination at the step S21, when it is determined that the shelf code information is obtained (the step S21: Yes), the shelf management unit 112 determines the security level of the goods shelf SH which the user wants to use on the basis of the shelf code information (a step S22). Specifically, the QR code SHC includes the information for identifying the goods shelf SH in which the QR code SHC is placed. Thus, the shelf management unit 112 can determine which of the plurality of goods shelves SH placed in the store ST is the goods shelf SH which the user wants to use on the basis of the shelf code information. Then, the shelf management unit 112 determines the security level of the goods shelf SH which the user wants to use on the basis of the usage condition data (especially, the shelf condition data illustrated in FIG. 6A).

Then, the shelf management unit 112 determines whether or not the user is permitted to use the goods shelf SH on the basis of the usage condition data (especially, the user condition data illustrated in FIG. 6B) (a step S23). Namely, the shelf management unit 112 determines whether or not the user is permitted to use the goods shelf SH the security level of which is determined at the step S22 on the basis of the usage condition data (the step S23).

For example, the user the user ID of which is 0002 illustrated in FIG. 6B is permitted to use the goods shelf SH the security level of which is set to be either one of the level 1 to the level 3. Thus, when the user the user ID of which is 0002 illustrated in FIG. 6B wants to use the goods shelf SH the shelf ID of which is 0001, 0002, 0003 or 0004 illustrated in FIG. 6A, the shelf management unit 112 determines that the user is permitted to use the goods shelf SH. On the other hand, when the user the user ID of which is 0002 illustrated in FIG. 6B wants to use the goods shelf SH the shelf ID of which is 0xyz illustrated in FIG. 6A, the shelf management unit 112 determines that the user is not permitted to use the goods shelf SH.

As a result of the determination at the step S23, when it is determined that the user is permitted to use the goods shelf SH (the step S23: Yes), the shelf management unit 112 performs a permission process that should be performed when the user is permitted to use the goods shelf SH (a step S25). For example, when the user wants to use the goods shelf SH (level 2), the shelf management unit 112 may perform, as the permission process, a process for transmitting a control command information for controlling the alert apparatus SHA not to output the alert to the alert apparatus SHA. For example, when the user wants to use the goods shelf SH (level 2), the shelf management unit 112 may perform, as the permission process, a process for not transmitting a control command information for controlling the alert apparatus SHA to output the alert to the alert apparatus SHA. For example, when the user wants to use the goods shelf SH (level 3) or the goods shelf SH (level 4), the shelf management unit 112 may perform, as the permission process, a process for transmitting the unlocking command information for unlocking the door SHD to the door SHD.

Incidentally, when the user wants to use the goods shelf SH (level 4), the two factor authentication is necessary for the user to use the goods shelf SH. Thus, when the two factor authentication is not completed, the shelf management unit 112 does not perform the permission process even when it is determined that the user is permitted to use the goods shelf SH at the step S23. Namely, the shelf management unit 112 performs the permission process when it is determined that the user is permitted to use the goods shelf SH at the step S23 and the two factor authentication is completed.

On the other hand, as a result of the determination at the step S23, when it is determined that the user is not permitted to use the goods shelf SH (the step S23: No), the shelf management unit 112 does not perform the permission process as a general rule. In this case, the shelf management unit 112 may perform a non-permission process that should be performed when the user is not permitted to use the goods shelf SH. For example, when the user wants to use the goods shelf SH (level 2), the shelf management unit 112 may perform, as the non-permission process, the process for transmitting the control command information for controlling the alert apparatus SHA to output the alert to the alert apparatus SHA. For example, when the user wants to use the goods shelf SH (level 3) or the goods shelf SH (level 4), the shelf management unit 112 may perform, as the non-permission process, a process for not transmitting the unlocking command information for unlocking the door SHD to the door SHD.

However, as illustrated in FIG. 9, the shelf management unit 112 may determine whether or not a predetermined additional condition is satisfied (a step S24) when it is determined that the user is not permitted to use the goods shelf SH. As a result of the determination at the step S24, when it is determined that the additional condition is satisfied (the step S24: Yes), the shelf management unit 112 may perform the permission process as an exceptional case. On the other hand, as a result of the determination at the step S24, when it is determined that the additional condition is not satisfied (the step S24: No), the shelf management unit 112 does not perform the permission process. However, the shelf management unit 112 may not necessarily determine whether or not the additional condition is satisfied.

The additional condition may include a condition that a manager that manages the store ST permits the user to use the goods shelf SH. The manager is a person that is authorized to permit the user to exceptionally use the goods shelf SH, for example. In this case, the shelf management unit 112 may transmit, to a manager terminal that is operable by the manager, an application information for applying to the manager for the usage of the goods shelf by the user. Alternatively, the user himself may transmit the application information to the manager terminal by using the user terminal 2. Then, when the manager terminal transmits, to the store management server 1, an permission information for indicating that the user is permitted to use the goods shelf SH, the shelf management unit 112 may determine that the additional condition is satisfied. On the other hand, when the manager terminal does not transmit the permission information to the store management server 1, the shelf management unit 112 may determine that the additional condition is not satisfied.

The manager may determine whether or not to permit the user to use the goods shelf SH on the basis of an information relating to the goods shelf SH included in the application information. For example, when the goods that is displayed on the goods shelf SH is not the expensive goods so much, the manager may determine to permit the user to use the goods shelf SH. The manager may determine whether or not to permit the user to use the goods shelf SH on the basis of an information relating to the user included in the application information. For example, when the identity of the user is certain, the manager may determine to permit the user to use the goods shelf SH. The manager may determine whether or not to permit the user to use the goods shelf SH on the basis of an action of the user the image of which is captured by the security camera CA. For example, when the user does not take a suspicious action, the manager may determine to permit the user to use the goods shelf SH.

The additional condition may include a condition that the shelf management unit 112 obtains the read result of the QR code SHC, which is placed in the goods shelf SH which the user wants to use, by a third party. Namely, the additional condition may include a condition that the shelf management unit 112 obtains the read result of the QR code SHC by the third party that is different from the user in addition to the read result of the QR code SHC by the user that wants to use the goods shelf SH. In this case, the usage of the goods shelf SH is permitted as the exceptional case on the condition that the user is paired with the third party, although only the user is not permitted to use the goods shelf SH. As a result, the usage of the goods shelf SH is permitted as the exceptional case even when the permission from the manager is not obtained because the above described manager of the store ST is absent. Even when the usage of the goods shelf SH by the user is permitted as the exceptional case, there is a relatively low possibility that the user takes a malicious action (for example, an action of steeling the goods) because there is the third party near the user. As a result, the security of the store ST is still maintained. Note that the third party is preferably a worker of the store ST, however, may be different from the worker of the store ST. For example, the third party may be another user that is purchasing the goods in the store ST.

Then, the shelf management unit 112 manages, as at least a part of a history information relating to the usage history, an information relating to the usage history of the goods shelf SH that the user uses in this time (a step S26). For example, the shelf management unit 112 makes the storage apparatus 12 newly store, as at least a part of the history information relating to the usage history, the information relating to the usage history of the goods shelf SH that the user uses in this time. In this case, the shelf management unit 112 may make the storage apparatus 12 store, as at least a part of the history information relating to the usage history, at least one of an information for determining the user that uses the goods shelf SH, an information for determining the goods shelf SH which the user uses and an information for determining a time at which the user uses the goods shelf SH.

Note that the QR code SHC is not necessarily placed in the goods shelf SH (level 1) the security level of which is set to be the level 1. Thus, it can be said that the operation illustrated in FIG. 9 is typically an operation that is performed when the user purchases the goods that is displayed on the goods shelf SH the security level of which is set to be either one of the level 2 to the level 4. However, the QR code SHC may be placed in the goods shelf SH (level 1). In this case, the read result of the QR code SHC may be used for the purpose of the shelf management unit 112 managing the usage history of the goods shelf SH used by the user.

(2-3) Operation for Changing Usage Condition Data

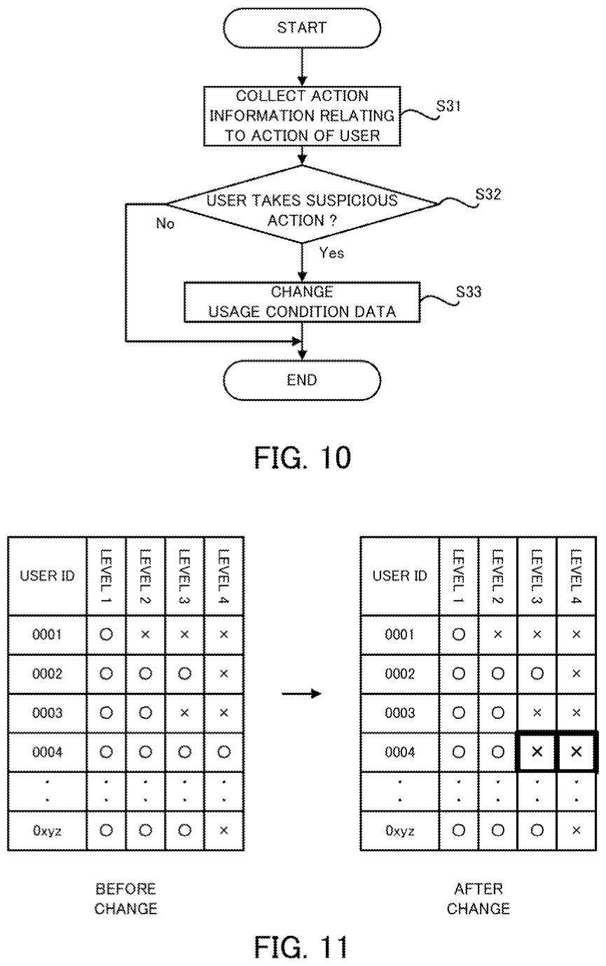

Next, with reference to FIG. 10, the operation for changing the usage condition data will be described. FIG. 9 is a flowchart that illustrates a flow of the operation for changing the usage condition data. Note that the operation illustrated in FIG. 10 may be performed repeatedly by the store management server 1. Namely, when the operation illustrated in FIG. 10 ends, the store management server 1 may start the operation illustrated in FIG. 10 again after a predetermined time elapses.

As illustrated in FIG. 10, the condition management unit 113 obtains an action information relating to an action of the user in the store ST (especially, in the shopping space SP) (a step S31). For example, the condition management unit 13 may obtain, as at least a part of the action information, the image (for example, at least one of a still picture and a movie) of the user captured by the security camera CA from the security camera CA placed in the shopping space SP. The obtained action information may be stored in the storage apparatus 12.

Then, the condition management unit 113 determines whether or not the user takes a suspicious action on the basis of the action information obtained at the step S31 (a step S32). The suspicious action may include an action that is different from an usual action f of the user that purchases the goods. Especially, the suspicious action may include an action that is undesirable for the security of the store ST. The suspicious action may include an action that would leads to an action that is malicious to the goods (for example, a theft, a joke or a destruction).

For example, usually, a time during which the user stays in the store ST to purchase the goods in the store ST is rarely longer than a certain time that is determined on the basis of a largeness of the store ST. Conversely, there is a possibility that the user that stays in the store ST longer than a certain time takes or will take the action that is different from the action of purchasing the goods that is usually taken in the store ST. Thus, the suspicious action may include an action that the user stays in the store ST longer than an allowable time (typically, a time that is longer than a time during which the usual user stays in the store ST).

For example, usually, the user rarely opens and closes the door SHD of the goods shelf SH many times than necessary when the user picks up the goods displayed on the goods shelf SH. Conversely, there is a possibility that the user that opens and closes the door SHD many times than necessary takes or will take the action that is different from the action of purchasing the goods that is usually taken in the store ST. Thus, the suspicious action may include an action that the user opens and closes the door SHD of the goods shelf SH an allowable number of times or more (typically, times that are larger than times which the usual user opens the door SHD to purchase the goods).

For example, there is a possibility that the user that looks around in a space in which another user does not exist takes or will take the action that is different from the action of purchasing the goods that is usually taken in the store ST. Thus, the suspicious action may include an action that the user looks around in a space in which another user does not exist.

As a result of the determination at the step S32, when it is determined that the user takes the suspicious action (the step S32: Yes), the condition management unit 113 changes the usage condition data (a step S33). For example, the condition management unit 113 may change the usage condition data so that the user that takes the suspicious action is less likely to use the goods shelf SH (namely, is less likely to pick up the goods displayed on the goods shelf SH). For example, the condition management unit 113 may change the usage condition data so that the usage of the goods shelf SH by the user that takes the suspicious action is restricted. In this case, the condition management unit 113 may change the usage condition data so as to decrease the type of the security level of the user that takes the suspicious action. As one example, FIG. 11 illustrates an aspect in which the usage condition data (especially, the user condition data) relating to the user the user ID of which is 0004 is changed. In an example illustrated in FIG. 11, the user that has been permitted to use the goods shelf SH the security level of which is set to be either one of the level 1 to the level 4 before the usage condition data is changed is permitted to use the goods shelf SH the security level of which is set to be either one of the level 1 to the level 2 after the usage condition data is changed. Namely, the user that has been permitted to use the goods shelf SH the security level of which is set to be either one of the level 1 to the level 4 before the usage condition data is changed is not permitted to use the goods shelf SH the security level of which is set to be either one of the level 3 to the level 4 after the usage condition data is changed. As a result, the user that takes the suspicious action is permitted to use only the goods shelf SH the security level of which is relatively mild. Thus, even when the user that takes the suspicious action is about to take the action that is malicious to the goods (for example, the theft, the joke or the destruction), the damage is relatively reduced. Alternatively, even when the user that takes the suspicious action is about to take the action that is malicious to the goods, the user cannot user the goods shelf SH (namely, cannot pick up the goods) due to the change of the usage condition information and thus the damage is properly prevented.

Note that FIG. 11 illustrates an example in which the condition management unit 113 changes the user condition data included in the usage condition data, however, the condition management unit 113 may change the shelf condition data (see FIG. 6A) included in the usage condition data. Namely, the condition management unit 113 may change the security level itself of the goods shelf SH so that the user that takes the suspicious action is less likely to use the goods shelf SH.

On the other hand, as a result of the determination at the step S32, when it is determined that the user does not take the suspicious action (the step S32: No), the condition management unit 113 may not change the usage condition data.

The condition management unit 113 may perform the operation illustrated in FIG. 10 for the user in at least a part of a period when the user stays in the store ST. Namely, the condition management unit 113 may determine whether or not the user staying in the store ST takes the suspicious action and change the usage condition data relating to the user that takes the suspicious action in a situation where the user stays in the store ST when it is determined that the user takes the suspicious action. In this case, a quick measurement to the user that takes the suspicious action is possible.

Alternatively, the condition management unit 113 may perform the operation illustrated in FIG. 10 for the user in at least a part of a period when the user does not stay in the store ST. The condition management unit 113 may perform the operation illustrated in FIG. 10 for the user in at least a part of a period after the user leaves the store ST and before the user enters the store ST again. Namely, the condition management unit 113 may determine whether or not the user takes the suspicious action in the period when the user stays in the store ST and change the usage condition data relating to the user that takes the suspicious action before the user visits the store ST next when it is determined that the user takes the suspicious action. In this case, even when the user that has taken the suspicious action visits the store to be about to take the action that is malicious to the goods, the damage due to the malicious action is relatively reduced because the usage of the goods shelf SH by the user is restricted.

(3) Technical Effect of Store Management System SYS

As described above, according to the store management system SYS in the present example embodiment, the user can use the goods shelf SH by reading the QR code SHC. Namely, the user can use the goods shelf SH without requesting the usage of the goods shelf SH (for example, the unlocking of the door SHD) to the workers of the store ST. Thus, a manpower necessary for the store ST is reducible, because no worker is required to respond the request from the user relating to the usage of the goods shelf SH.

Moreover, according to the store management system SYS, the user can user the goods shelf SH by reading the QR code SHC with the user terminal 2 which the user has. Thus, a physical key for unlocking the door SHD of the goods shelf SH is not necessary to use the goods shelf SH. Thus, an occurrence of a trouble caused by a lending and borrowing of the physical key (for example, a user that is not authorized to use the goods shelf SH illegally uses the goods shelf SH by using the key that is borrowed from a user that is authorized to use the goods shelf SH) is appropriately prevented.

Moreover, since reading the QR code SHC is required to user the goods shelf SH, the store management system SYS can properly manage the usage history of the goods shelf SH by the user on the basis of the read result of the QR code SHC. Thus, the store management system SYS can promptly identify the user that takes the action that is malicious to the goods. Furthermore, since the usage history is always managed (namely, the action of the user is substantially monitored), it is expected that a motivation of the user for intentionally taking the action that is malicious to the goods is small. Therefore, the security of the store ST is properly secured.

Moreover, the store management system SYS can flexibly change the usage condition data that indicates the condition for the user to use the goods shelf SH. Especially, the store management system SYS can properly manage the usage of the goods shelf SH by the user in accordance with the actual action of the user in the store ST as described above.

(4) Modified Example

(4-1) Modified Example Regarding Operation for Changing Usage Condition Data

In the above described description, the condition management unit 113 changes the usage condition data on the basis of the action information relating to the action of the user. However, the condition management unit 113 may change the usage condition data on the basis of any information relating to the user. For example, the condition management unit 113 may change the usage condition data on the basis of an information relating to the goods purchased by the user. Specifically, when the number of the goods actually purchased by the user is significantly less than the number of times the user uses the goods shelf SH (namely, the number of times the user picks up the goods), there is a possibility that the user takes or will take the action that is that is different from the action of purchasing the goods that is usually taken in the store ST. There is a possibility that the user weighs the goods which he intends to steal. Thus, when it is determined that the number of the goods actually purchased by the user is significantly less than the number of times the user uses the goods shelf SH on the basis of the information relating to the goods purchased by the user, the condition management unit 113 may change the usage condition data so that the usage of the goods shelf SH by the user is restricted.

In the above described description, the condition management unit 113 changes the usage condition data on the basis of the information relating to the user. However, the condition management unit 113 may change the usage condition data on the basis of any information that is usable for changing the usage condition data. For example, the condition management unit 113 may change the usage condition data on the basis of an information relating to a current time. Specifically, when the current time is a time (for example, an early morning or a night) in which there are fewer users staying in the store ST, the number of other user that can watch one user staying in the store ST becomes relatively small. Namely, there is a relatively low possibility that other user exists around the user staying in the store ST. As a result, there is a possibility that the action that is malicious to the goods by one user that is not watched by other user is encouraged. Thus, the current time is the time in which there are fewer users staying in the store ST, the condition management unit 113 may change the usage condition data so that the usage of the goods shelf SH by the user is restricted. For example, the current time is the time in which there are fewer users staying in the store ST, the condition management unit 113 may change the usage condition data so that the usage of the goods shelf SH by all (alternatively, partial) users is restricted, compared to the case where the current time is not the time in which there are fewer users staying in the store ST.

The condition management unit 113 changes the usage condition data on the basis of the action information relating to the action of the user (alternatively, any information that is usable for changing the usage condition data). However, the condition management unit 113 may change the usage condition data independently from the action information relating to the action of the user (alternatively, any information that is usable for changing the usage condition data). For example, the condition management unit 113 may select the user randomly and change the usage condition data relating to the randomly selected user at a random timing. In this case, the usage of the goods shelf SH is suddenly restricted (namely, the goods shelf SH cannot be used unless more stringent condition is satisfied), and thus, it is expected to provide a sense of tension to the user, and as a result, to reduce a possibility that the user takes the malicious action.

When it is determined that the user takes the suspicious action, the condition management unit 113 may notify the manager and so on of the existence of the user that takes the suspicious action, in addition to or instead of changing the usage condition data. As a result, the condition management unit 113 can prompt the manager to take a measurement for the user that takes the suspicious action.

(4-2) Other Modified Example

In the above described description, the store management server 1 identifies the user that is about to enter the store ST on the basis of the read result of the QR code ENC. However, the store management server 1 may identify the user that is about to enter the store ST on the basis of a read result of any code (for example, a code that is optically readable or a code that is electromagnetically readable) that is different from the QR code ENC. The store management server 1 may identify the user that is about to enter the store ST by using any method for identifying the user. A method for identifying the user by perming a biometric authentication (for example, a face authentication) is one example of any method for identifying the user.

In the above described description, the store management server 1 transmits the unlocking command for unlocking the entrance door END to the entrance door END after identifying the user that is about to enter the store ST. This is because the entrance door END is usually a locked door. However, the entrance door END may not be locked. The entrance door END may not be placed at the entrance ENT. In this case, the store management server 1 may not transmit the unlocking command for unlocking the entrance door END to the entrance door END. Incidentally, the store management server 1 preferably performs the identification process for identifying the user that is about to enter the store ST in order to manage the user that stays in the store ST, however, may not perform the identification process.

A detection apparatus that detects whether or not the goods is actually picked up from the goods shelf SH may be placed in the goods shelf SH. At least one of a sensor that detects a weight of the goods displayed on the goods shelf SH, a camera that captures an image of the goods displayed on the goods shelf SH and a read apparatus that reads a RF tag attached to the goods is one example of this detection. In this case, the shelf management unit 112 may make the storage apparatus 13 store, as a part of the history information, an information relating to the goods that is actually picked up from the goods shelf SH by the user.

The door SHD placed in the goods shelf SH may be automatically locked at a timing that it is closed by the user. In this case, the shelf management unit 112 does not necessarily transmits a locking command for locking the door SHD to the door SHD. As a result, a processing load of the store management server 1 is reducible.

In the above described description, the QR code SHC is placed in the goods shelf SH. However, any code that is different from the QR code SHC may be placed in the goods shelf SH. Any code may include a conde that is optically readable (for example, a one-dimensional code or a two-dimensional code). Any code may include a code that is electromagnetically readable (for example, a RF (Radio Frequency) tag).

In the above described description, the store management system SYS manages the usage of the goods shelf SH by the user that visits the store ST in which the goods shelf SH on which the goods is displayed is placed. However, the store management system SYS may manage an usage of a storage by the user that enters a facility in which the storage for storing any article is placed. The storage is a tool (alternatively, an apparatus) including a member that is configured to form any storage space (in other words, a housing space or a display space) at least one of any box, any container and any shelf is one example of the storage. In this case, the store management system SYS and the store management server 1 may be referred to as an article management system and an article management apparatus (an article management server), respectively. For example, the store management system SYS may manage an usage of the shelf by the user (for example, a worker that works in a storehouse) that enters the store house in which the shelf for storing a goods is placed. For example, the store management system SYS may manage an usage of the container by the user (for example, a worker that works in a pharmacy and the like) that enters a medicine closet in which the container for storing a medical product is placed.

When the usage of the storage by the user that enters the facility in which the storage for storing any article is placed is managed, the above described additional condition that the shelf management unit 112 obtains the read result of the QR code SHC by the third party that is different from the user that wants to user the storage is especially advantageous in that the usage of the goods shelf SH is permitted in an emergent case. For example, the usage of the container is permitted as the exceptional case on the condition that one user is paired with the third party (for example, a registered seller), although one user (for example, a pharmacist) is not normally permitted to use the medical product stored in the container alone. Thus, the medical product can be used as the exceptional case in a situation where the medical product is urgently needed despite the absence of a manager (for example, a supervising pharmacist) that is authorized to permit the exceptional usage of the container.

(5) Supplementary Note

With respect to the example embodiments described above, the following Supplementary Notes will be further disclosed.

[5-1] Supplementary Note 1

An article management apparatus including:

an identifying unit that performs an identification process for identifying a user that enters a facility in which a storage for an article is placed;

a storing unit that stores usage condition data that defines a condition for the user that is identified by the identifying unit to use the storage; and

a changing unit that performs a change process for changing the usage condition data stored in the storing unit on the basis of a predetermined change information that is usable for changing the usage condition data.

[5-2] Supplementary Note 2

The article management apparatus according to the Supplementary Note 1, wherein

the change information includes a user information relating to the user.

[5-3] Supplementary Note 3

The article management apparatus according to the Supplementary Note 2, wherein

the user information includes an action information relating to an action of the user in the facility.

[5-4] Supplementary Note 4

The article management apparatus according to the Supplementary Note 3, wherein

the changing unit changes the usage condition data so that the usage of the storage by the user is restricted when it is determined on the basis of the action information that the user take a suspicious action in the facility.

[5-5] Supplementary Note 5

The article management apparatus according to the Supplementary Note 4, wherein

the suspicious action includes at least one of an action that the user stays in the facility longer than an allowable time, an action that the user opens and closes a door that separates an inside and an outside of the storage an allowable number of times or more and an action that the user looks around in a space in which another user does not exist.

[5-6] Supplementary Note 6

The article management apparatus according to any one of the Supplementary Notes 1 to 5, wherein

the changing unit changes the usage condition data in a period during which the user stays in the facility.

[5-7] Supplementary Note 7

The article management apparatus according to any one of the Supplementary Notes 1 to 6, wherein

the changing unit changes the usage condition data in a period after the user leaves the facility and before the user enters the facility again.

[5-8] Supplementary Note 8

The article management apparatus according to any one of the Supplementary Notes 1 to 7, wherein

the changing unit changes the usage condition data at a timing that is selected randomly.

[5-9] Supplementary Note 9

The article management apparatus according to any one of the Supplementary Notes 1 to 8 further including a managing unit that (i) determines on the basis of the usage condition information whether or not to the usage of the storage by the user is permitted when it receives a request information relating to a request from the user that wants to use the storage, and (ii) performs a predetermined management process that should be performed when the usage of the storage is permitted when it is determined that the usage of the storage by the user is permitted,

the management unit performing the management process on the condition that a predetermined additional condition is satisfied even when it is determined that the usage of the storage by the user is not permitted.

[5-10] Supplementary Note 10

An article management apparatus including:

an identifying unit that performs an identification process for identifying a user that enters a facility in which a storage for an article is placed;

a storing unit that stores usage condition data that defines a condition of the storage that is usable by the user; and

a managing unit that determines on the basis of the usage condition information whether or not the usage of the storage by the user is permitted when it receives a request information relating to a request from the user that wants to use the storage, and performs a predetermined management process that should be performed when the usage of the storage is permitted when it is determined that the usage of the storage by the user is permitted,

the management unit performing the management process on the condition that a predetermined additional condition is satisfied even when it is determined that the usage of the storage by the user is not permitted.

[5-11] Supplementary Note 11

The article management apparatus according to the Supplementary Note 9 or 10, wherein

the additional condition includes at least one of a condition that a request information relating to a request from a third party relating to the usage of the storage by the user and a condition that a manager that manages the facility and receives an application from the user permits the user to use the storage.

[5-12] Supplementary Note 12

The article management apparatus according to any one of the Supplementary Notes 9 to 11, wherein

the storage is locked,

the management process includes a process for outputting a command to unlock the storage.

[5-13] Supplementary Note 13

The article management apparatus according to any one of the Supplementary Notes 1 to 12, wherein

the storage is locked,

the usage condition data includes unlocking condition data relating to an unlocking condition that indicates whether or not to permit an unlocking of the storage for the user.

[5-14] Supplementary Note 14

An article management system including:

an information terminal that is usable by a user that enters a facility in which a storage for an article is placed; and

an article management apparatus that manages an usage of the storage by the user,

the information terminal including a transmitting unit that transmits, to the article management apparatus, a request information relating to a request from the user that wants to use the storage,

the article management apparatus including:

an identifying unit that performs an identification process for identifying the user;

a storing unit that stores usage condition data that defines a condition for the user that is identified by the identifying unit to use the storage;

a managing unit that manages the usage of the storage by the user on the basis of the request information and the usage condition data; and

a changing unit that performs a change process for changing the usage condition data stored in the storing unit on the basis of a predetermined change information that is usable for changing the usage condition data.

[5-15] Supplementary Note 15

An article management system including:

an information terminal that is usable by a user that enters a facility in which a storage for an article is placed; and

an article management apparatus that manages an usage of the storage by the user,

the information terminal including a transmitting unit that transmits, to the article management apparatus, a request information relating to a request from the user that wants to use the storage,

the article management apparatus including:

an identifying unit that performs an identification process for identifying the user;

a storing unit that stores usage condition data that defines a condition for the user that is identified by the identifying unit to use the storage;

a managing unit that (i) determines on the basis of the usage condition information whether or not the usage of the storage by the user is permitted when it receives the request information, and (ii) performs a predetermined management process that should be performed when the usage of the storage is permitted when it is determined that the usage of the storage by the user is permitted,

the management unit performing the management process on the condition that a predetermined additional condition is satisfied even when it is determined that the usage of the storage by the user is not permitted.

[5-16] Supplementary Note 16

An article management method including:

performing an identification process for identifying a user that enters a facility in which a storage for an article is placed; and

performing a change process for changing usage condition data that defines a condition for the identified user to use the storage on the basis of a predetermined change information that is usable for changing the usage condition data.

[5-17] Supplementary Note 17

An article management method including:

performing an identification process for identifying a user that enters a facility in which a storage for an article is placed;

determining, on the basis of usage condition information that defines a condition of the storage that is usable by the user, whether or not the usage of the storage by the user is permitted when a request information relating to a request from the user that wants to use the storage is received;

performing a predetermined management process that should be performed when the usage of the storage is permitted when it is determined that the usage of the storage by the user is permitted; and

performing the management process on the condition that a predetermined additional condition is satisfied even when it is determined that the usage of the storage by the user is not permitted.

[5-18] Supplementary Note 18

A recording medium on which a computer program allowing a computer to execute an article management method is recorded,

the article management method including:

performing an identification process for identifying a user that enters a facility in which a storage for an article is placed; and

performing a change process for changing usage condition data that defines a condition for the identified user to use the storage on the basis of a predetermined change information that is usable for changing the usage condition data.

[5-19] Supplementary Note 19

A recording medium on which a computer program allowing a computer to execute an article management method is recorded,

the article management method including:

performing an identification process for identifying a user that enters a facility in which a storage for an article is placed;

determining, on the basis of usage condition information that defines a condition of the storage that is usable by the user, whether or not the usage of the storage by the user is permitted when a request information relating to a request from the user that wants to use the storage is received;

performing a predetermined management process that should be performed when the usage of the storage is permitted when it is determined that the usage of the storage by the user is permitted; and

performing the management process on the condition that a predetermined additional condition is satisfied even when it is determined that the usage of the storage by the user is not permitted.

[5-20] Supplementary Note 20

A computer program allowing a computer to execute an article management method is recorded,

the article management method including:

performing an identification process for identifying a user that enters a facility in which a storage for an article is placed; and

performing a change process for changing usage condition data that defines a condition for the identified user to use the storage on the basis of a predetermined change information that is usable for changing the usage condition data.

[5-21] Supplementary Note 21

A computer program allowing a computer to execute an article management method is recorded,

the article management method including:

performing an identification process for identifying a user that enters a facility in which a storage for an article is placed;

determining, on the basis of usage condition information that defines a condition of the storage that is usable by the user, whether or not the usage of the storage by the user is permitted when a request information relating to a request from the user that wants to use the storage is received;

performing a predetermined management process that should be performed when the usage of the storage is permitted when it is determined that the usage of the storage by the user is permitted; and

performing the management process on the condition that a predetermined additional condition is satisfied even when it is determined that the usage of the storage by the user is not permitted.

The present invention is allowed to be changed, if desired, without departing from the essence or spirit of the invention which can be read from the claims and the entire specification, and a parameter determination apparatus, an article management apparatus, an article management system, an article management method, a recording medium and a computer program, which involve such changes, are also intended to be within the technical scope of the present invention.

This application is based upon and claims the benefit of priority from Japanese Patent Application No. 2019-174145, filed on Sep. 25, 2019, and incorporates all of its disclosure herein, if legally permitted. Moreover, this application incorporates all of the publications of application and articles, if legally permitted.

### DESCRIPTION OF REFERENCE CODES

1 store management server
11 CPU
111 identification unit
112 shelf management unit
113 condition management unit
12 storage apparatus
2 user terminal
SH goods shelf

What is claimed is:

1. An article management apparatus comprising:
at least one memory configured to store instructions; and
at least one processor configured to execute the instructions to:
perform an identification process for identifying a user that enters a facility in which a storage for an article is placed; and
perform a change process for changing a usage condition data that defines a condition for the identified user to use the storage on the basis of a predetermined change information that is usable for changing the usage condition data.

2. The article management apparatus according to claim 1, wherein
the change information includes a user information relating to the user.

3. The article management apparatus according to claim 2, wherein
the user information includes an action information relating to an action of the user in the facility.

4. The article management apparatus according to claim 3, wherein
at least one processor is configured to execute the instruction to change the usage condition data so that the usage of the storage by the user is restricted when it is determined on the basis of the action information that the user take a suspicious action in the facility.

5. The article management apparatus according to claim 4, wherein
the suspicious action includes at least one of an action that the user stays in the facility longer than an allowable time, an action that the user opens and closes a door that separates an inside and outside of the storage an allowable number of times or more and an action that the user looks around in a space in which another user does not exist.

6. The article management apparatus according to claim 1, wherein
at least one processor is configured to execute the instruction to change the usage condition data in a period during which the user stays in the facility.

7. The article management apparatus according to claim 1, wherein
at least one processor is configured to execute the instruction to change the usage condition data in a period after the user leaves the facility and before the user enters the facility again.

8. The article management apparatus according to claim 1, wherein
at least one processor is configured to execute the instruction to change the usage condition data at a timing that is selected randomly.

9. The article management apparatus according to claim 1, wherein
at least one processor is further configured to execute the instructions to (i) determine on the basis of the usage condition information whether or not to the usage of the storage by the user is permitted when it receives a request information relating to a request from the user that wants to use the storage, and (ii) perform a predetermined management process that should be performed when the usage of the storage is permitted when it is determined that the usage of the storage by the user is permitted,
at least one processor is configured to execute the instruction to perform the management process on the condition that a predetermined additional condition is satisfied even when it is determined that the usage of the storage by the user is not permitted.

10. An article management apparatus comprising:
at least one memory configured to store instructions; and
at least one processor configured to execute the instructions to:
perform an identification process for identifying a user that enters a facility in which a storage for an article is placed; and
determine on the basis of a usage condition information that defines a condition for the identified user to use the storage whether or not the usage of the storage by the user is permitted when it receives a request information relating to a request from the user that wants to use the storage, and performs a predetermined management process that should be performed when the usage of the storage is permitted when it is determined that the usage of the storage by the user is permitted,
at least one processor being configured to execute the instruction to perform the management process on the condition that a predetermined additional condition is satisfied even when it is determined that the usage of the storage by the user is not permitted.

11. The article management apparatus according to claim 10, wherein
the additional condition includes at least one of a condition that a request information relating to a request from a third party relating to the usage of the storage by the user and a condition that a manager that manages the facility and receives an application from the user permits the user to use the storage.

12. The article management apparatus according to claim 10, wherein
the storage is locked,
the management process includes a process for outputting a command to unlock the storage.

13. The article management apparatus according to claim 1 wherein
the storage is locked,
the usage condition data includes unlocking condition data relating to an unlocking condition that indicates whether or not to permit an unlocking of the storage for the user.

14-15. (canceled)

16. An article management method comprising:
performing an identification process for identifying a user that enters a facility in which a storage for an article is placed; and
performing a change process for changing usage condition data that defines a condition for the identified user to use the storage on the basis of a predetermined change information that is usable for changing the usage condition data.

17-19. (canceled)
